(19) United States
(12) Patent Application Publication
(10) Pub. No.: US 2025/0114730 A1
(43) Pub. Date: Apr. 10, 2025

(54) FILTER CLEANING SYSTEM AND METHOD

(71) Applicant: John Bean Technologies Corporation, Chicago, IL (US)

(72) Inventors: Pablo Filgueira Rodeiro, Kingston, NY (US); Jeffrey C. Gill, Stone Ridge, NY (US); Derek Sean Mobbs, Russellville, AR (US)

(73) Assignee: John Bean Technologies Corporation, Chicago, IL (US)

(21) Appl. No.: 18/482,142

(22) Filed: Oct. 6, 2023

(51) Int. Cl. B01D 29/68

(52) U.S. Cl. CPC B01D 29/682; B01D 2201/081

(57) ABSTRACT

A filter apparatus includes a cylindrical casing defining an inlet for receiving a liquid to be filtered and an outlet for the filtered liquid. A cylindrical filter element is disposed within the casing and is sized to define an annular volume between the exterior for the filter element and the interior of the casing. The annular volume is in fluid flow communication with the inlet. The particulate in the liquid is retained on the exterior of the filter element, while the liquid flows into the interior of the filter element. The filter element has a porous end adjacent the outlet for flow of the filtered liquid out the center of the filter element and through the outlet. Nozzles are disposed within the filter element, to direct a cleaning fluid at the interior surface of the filter element to wash the particulate off the exterior of the filter element.

### BACKGROUND

Meat processing operations include a wide variety of processing steps for preparing meat products for consumers. After slaughter, the animal carcass is cleaned, chilled, and then passed on to trimming operations in which large cuts of meat such as steaks, roasts, and filets are separated from the carcass. Special processing steps may be applied to the material left after the initial trimming operations to recover additional lean meat from the trimmings. Corresponding operations may be used to process other types of protein, such as fish and poultry (hereinafter sometimes collectively referred to a “product” or “food product”).

One common downstream treatment process includes injecting various liquids into the food product. The liquids may include flavor enhancing agents, microbe suppression agents, color enhancing agents, curing agents or liquids for otherwise imparting certain desired characteristics to the food product. Regardless of the purpose of the injected liquid, a liquid injected into a food product is commonly referred to as a “brine,” “pickle,” “marinade,” “emulsion,” or the like (hereinafter sometimes collectively referred to throughout as a “brine” or an “injection fluid” or similar term).

Brine injecting, for example, can be done using a brine injection machine that can be as simple as a small portable brine pump connected to a large syringe to industrial brining systems that have a head or multiple heads filled with arrays of hypodermic or side port needles injection needles. Industrial brining systems may be used to carry out a brining process including one or more of the following steps: (1) product placement on an infeed conveyor; (2) movement of the food product beneath the injection head (typically using a walking beam system or some type of conveyor belt system); (3) downward movement of the needles (via the head) to penetrate the needles into the product as the product moves along the processing path; (4) pumping of brine from a container (from a brine tank or other brine system) through the needles into the product; (5) retracting the needles from the product by moving the head upward; (6) movement of the product toward a machine exit for further processing or packaging. These brining steps may be accomplished by different methods depending on the type of brine injector used, the food product being processed, the throughput required, etc.

As can be appreciated, some of the needles may be outside the perimeter of the product being brined. Also, some of the injected brine may seep or leak out of the product. Such bring is typically collected and filtered for reuse. Various filtering systems are used to remove particulates from the brine liquid.

In current filtering systems it is necessary to periodically stop the filtering process and clean the filters, whether a mesh belt, screen or other filter material. Such cleaning may be carried out by using a scraper to scrape the particulate from the filtering material and/or using water to spray the particulate off the filter material. This cleaning process is time consuming and requires the use of significant quantities of cleaning water. Also, the used cleaning water must be treated for reuse or even before the water is disposed of.

The systems and method of the present disclosure seeks to address the shortcomings of current bring filtering systems and methods.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a filter apparatus is provided. The filter apparatus includes: a cylindrical casing defining an inlet for receiving a liquid to be filtered and an outlet spaced apart from the inlet along the length of the casing for the exiting of the filtered liquid; a cylindrical filter element disposed within the casing between the inlet and the outlet; the filter element have a diameter sized to define an annular volume between the exterior for the filter element and the interior of the casing, the annular volume in fluid flow communication with the inlet, the filter element having porous end adjacent the outlet for flow of the filtered liquid out the interior of the filter element and through the outlet; and a plurality of nozzles disposed within the filter element, the nozzles positioned to direct a cleaning fluid at the interior surface of the filter element.

In any of the embodiments described herein, wherein the filter element comprises a closed end cap forming the closed end of the filter element.

In any of the embodiments described herein, wherein the filter element comprises a porous end cap forming the porous end of the filter element.

In any of the embodiments described herein, wherein the filter element comprises a comprising a cylindrical media.

In any of the embodiments described herein, wherein the filter media have a pore size selected to prevent selected particulates from passing through the filter element.

In any of the embodiments described herein, wherein the nozzles are positioned and sized to remove particulates that have accumulated on the exterior of the filter media.

In any of the embodiments described herein, wherein the nozzles are mounted on a tube extending through the cylindrical filter element, the nozzles in fluid flow communication with the tube.

In any of the embodiments described herein, wherein the nozzles are positioned to direct the cleaning fluid radially outwardly from the tube.

In any of the embodiments described herein, wherein the nozzles comprise a torus-shaped chamber extending around the tube.

In any of the embodiments described herein, wherein the nozzles comprise openings in the torus-shaped chamber to direct a cleaning fluid disposed in the torus chamber outward toward the filter element.

In any of the embodiments described herein, wherein the tube is configured to rotate about an axis extending along the length of the tube to in turn rotate the nozzles about the axis.

In any of the embodiments described herein, wherein the tube is configured to translate in a direction along the length of the tube.

In any of the embodiments described herein, wherein the tube engages the filter element to position the filter element concentrically within the casing.

In any of the embodiments described herein, wherein the nozzles comprise a chamber extending around the tube and in fluid flow communication with the tube, the chamber defining openings to direct a cleaning fluid in the chamber outward toward the inner surface of the filter element.

In any of the embodiments described herein, wherein the chamber openings comprise slits in the chamber.

In any of the embodiments described herein, further comprising a valve that is adjustable between a first position to permit a liquid to be filtered to enter the annular volume and a second position to prevent the liquid to be filtered from entering the annular volume while permitting the cleaning fluid emitted by the nozzles to drain from the casing.

In any of the embodiments described herein, further comprising a plurality of casings, each having a filter element disposed therein and each having a plurality of nozzles disposed within the filter element, the nozzles positioned to direct a cleaning fluid at the interior surface of the filter element.

In any of the embodiments described herein, wherein the inlets of the plurality of casings are connected to a common inlet line.

In any of the embodiments described herein, wherein the outlets of the plurality of casings are connected to a common outlet line.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a cross-sectional view of a brine injection system;

FIG. 2 is an elevational view of a brine injection needle;

FIG. 3 is an enlarged cross-sectional view of the upper end of the brine injection needle of FIG. 2.

FIG. 4 is an isometric ring of a primary filter system;

FIG. 5 is a schematic view of the primary filter system of FIG. 4;

FIG. 6 is an isometric view of a secondary filter system;

FIG. 7 is a view similar to FIG. 6, with portions broken away to view interior components of the secondary filter system;

FIG. 8 is an isometric view of the cleaning nozzle subassembly of the secondary filter system;

FIG. 9 is a schematic diagram of an example of a brining system of the present disclosure.

### DETAILED DESCRIPTION

In the following description and in the accompanying drawings, corresponding systems, assemblies, apparatus, and units may be identified by the same part number, but with an alpha suffix. The descriptions of the parts/components of such systems assemblies, apparatus, and units that are the same or similar are not repeated so as to avoid redundancy in the present application.

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments.

The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present disclosure may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” these references and other similar references in the present application are only to assist in helping describe and understand the present disclosure and are not intended to limit the present invention to these directions.

The present disclosure may include modifiers such as the words “generally,” “approximately,” “about,” or “substantially.” These are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the present disclosure the terms “brine” and “marinade” and “pickle” and “emulsion” are all considered to be synonymous terms.

The present disclosure may be used in conjunction with various types of work products, including, for example, foods or food products. Such foods or food product can include various protein food products, such as meat, poultry fish and plant-based proteins. However other foods products may be processed using the systems and methods of the present disclosure, including fruits and vegetables. Further, a reference to a work product shall include all manner of food products. In addition, a reference to a food product shall be interpreted to include non-food products.

The present disclosure pertains to a system 100 and method of injecting work products, such as food products, with brine or other liquid-based substance and automatically cleaning by filtering the residual brine remaining after injecting the work product. The system 100 and method further includes using the brine itself to clean the filters. As an example of the system 100, a brine injection system 101 includes an injection head or needle carrier 102 configured to plunge an array of injection needles 104 in to and out of engagement with a work product to inject a brine into the work product. The residual brine remaining from the injection process is collected and filtered by a primary filter system 110. Thereafter, the filtered brine is routed to a saddle tank 112. From the saddle tank 112, the brine is routed, as needed, to a secondary filter 120 remove particulates from the brine that remain after the primary filtering of the brine, sufficient to enable the brine to be routed to the injection head 102 for reuse for injection into the work product.

In addition, clean brine is used to clean the primary filter system 110. Thereafter, the spent brine from this cleaning procedure is routed to the primary filter system 110 to undergo primary filtration in the same manner as the brine collected after being expelled by the injection head 102. After this primary filtration, the brine is routed to the saddle tank 112.

Clean brine is also used to clean the secondary filter system 120. Thereafter, the spent brine from this cleaning procedure is routed to the primary filter system 110 to undergo primary filtration in the same manner as the brine collected after being expelled by the injection head 102 and the spent brine from cleaning the primary filter. After this primary filtration, the brine from cleaning the secondary filter system is also routed to the saddle tank 112.

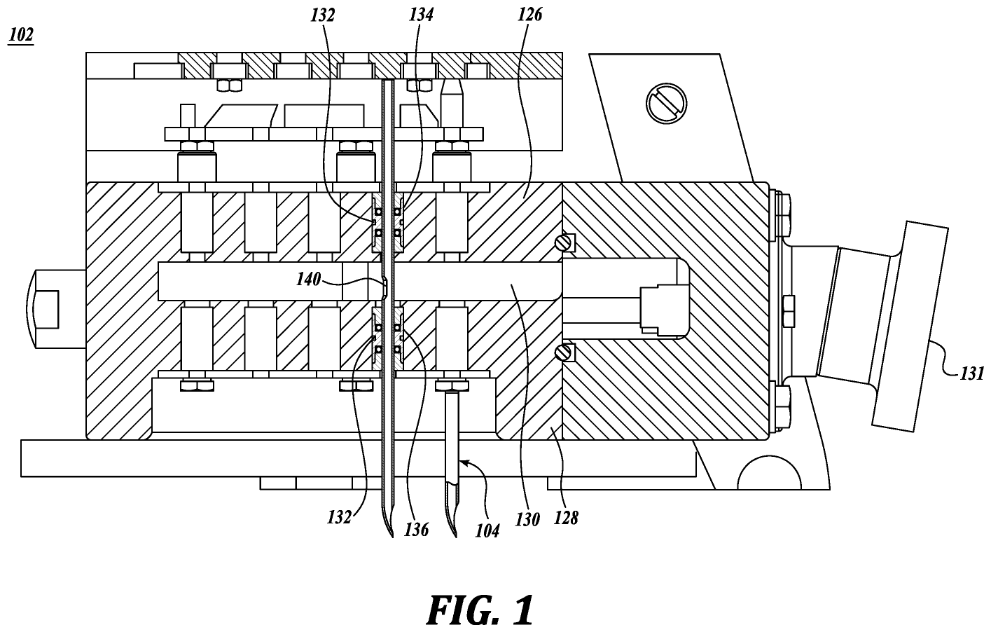

The system and method set forth above is described below in further detail. In this regard, FIG. 1 shows the injection head 102 of the injection system 101. The injection head 102 is configured to move a plurality of injection needles 104 into and out of engagement with a work product for injecting a brine or other liquid into the work product. The injection head may be moveable in a z-direction for injecting the needles into the work product and withdrawing the needles from the work product. The injection head may also be moveable laterally (in an x- and/or y-direction) by a gantry, robot, or other structure for locational placement of the injection needles into the work product. Instead, the injection head 102 may be stationary or may move only laterally and may apply a plunging force to the injection needles.

The injection head, as shown in FIG. 1, includes a carrier upper section 126 and a carrier lower section 128 which cooperatively define a feeder supply chamber 130 therebetween. An inlet port 131 connects the supply chamber 130 to the saddle tank 112 through the intermediacy of the secondary filter system 120.

The plurality of injection needles 104 are supported by the injection head 102. In this regard, seal rings 132 are disposed within counter bores 134 and 136 extending downwardly into the carrier upper section 126 and upwardly into the carrier lower section 128. The seal rings 132 are retained within the counter bores 134 and 136 to closely receive needles 104.

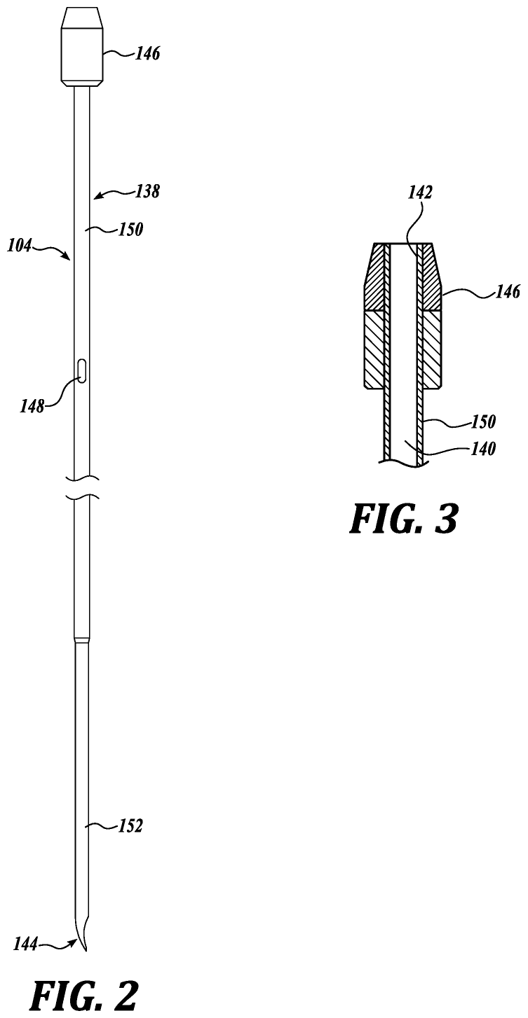

Referring to FIGS. 2 and 3, each injection needle 104 includes a cannula or an elongated hollow shank 138 having a hollow interior 140 extending along its length. The elongated hollow shank 138 is made in a manner well known in the art from a suitable material, such as hypodermic stainless steel or another alloy. For instance, the elongated hollow shank 138 may be made using a CNC automated process. The elongated hollow shank 138 includes an upper end 142 defined opposite a needle tip 144. The upper end 142 is securely engaged within an inner diameter of a head 146. The head 146 is constructed to receive the plunging force used to insert the needle tip 144 into the food product being processed.

Referring specifically to FIG. 2, the elongated hollow shank 138 includes an upper shank section 150 that is larger in outer diameter than a lower shank section 152. In one nonlimiting example, the upper shank section 150 may have a gauge or outer diameter in the range of 2.5-5 mm, and the lower shank section 152 may have an outer diameter of 2.0-2.5 mm. As a more specific example, the hollow shank 138 could be constructed with an upper shank section 150 having a 3.0 mm outer diameter and a lower shank section 152 with a 2.5 mm outer diameter. The enlarged upper shank section 150 enables brine to enter the needle sufficiently quickly (such as through inlet opening 148, described below) to keep the needle filled with brine during the injection process. On the other hand, the reduced diameter lower section 152 enables suitable penetration of the needle 104 into the food product. The upper and lower shank sections 150 and 152 may both have the same inside diameter suitable for injection, such as about 1.5 mm.

Referring to FIG. 2, an inlet opening 148 is formed in an upper shank section 150 so as to be in registry with the supply chamber 130 for filling the hollow interior 140 of the needle 104 with brine during the injection process. In the depicted exemplary embodiment, the inlet opening 148 is elongated and extends along a portion of the length of the upper shank section 150. The inlet opening 148 is shown as generally an elongated oval shape, although any other shape that allows for suitable filling of the injection needle 104 may instead be used.

The inlet opening 148 has a size configured to allow for suitable filling of the injection needle 104. As a non-limiting example, the length of the opening may be from about 5 mm to about 10 mm. Correspondingly, as a nonlimiting example, the width of the opening can be from about 2 mm to about 4 mm. In one specific example, the size of the opening 148 is about 7 mm in length and 2.5 mm in width. Of course, these dimensions may be increased or decreased in size depending, for instance, on the characteristics of the needle shank (e.g., inner/outer diameter, material, etc.) and/or the type of liquid (e.g., brine v. emulsion) being injected.

Nonetheless, the size of the inlet opening 180 and also the inside diameter of the needle interior 140 are quite small. As such, it is important to for the brine to be “clean” and free from particulates that could cause clogging of the inlet opening 180 and/or the in interior 140 of the needle 104.

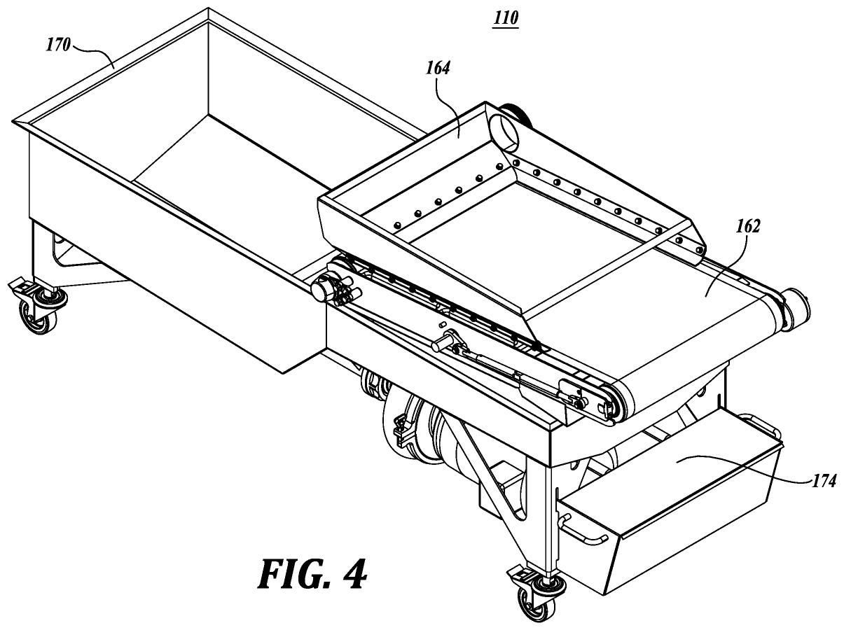

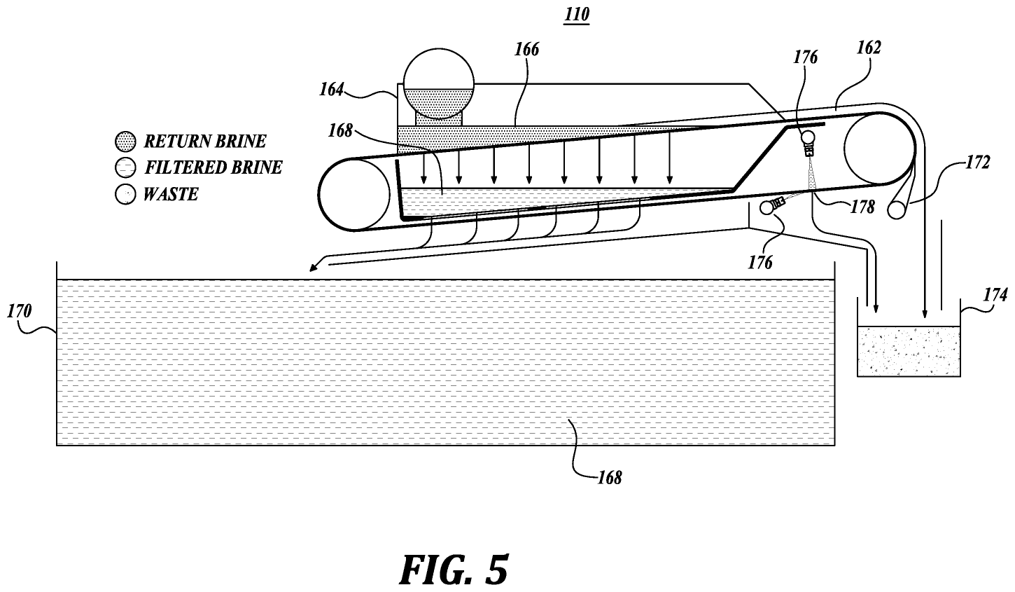

FIGS. 4 and 5 depict the primary stage or first stage of filter system 110. The filter system is constructed as a belt filter system. In this regard, the filter system 110 includes an endless filter belt 162 is mounted within a shallow, rectangular pan structure 164 that is sloped upwardly and open at its distal end. The used brine 166 collected from the injection system is deposited on the top of the endless filter belt 162, and liquid component of the brine flows down through the belt. The belt may be composed of a fine mesh material that allows passage of the liquid component of the brine, but not the particulates.

The filtered brine 168 is collected at the bottom of the pan structure 164 and then routed to a storage tank 170. The tank 170 is shown in FIG. 5 as located below the pan structure 164, but can be located elsewhere. Also, the tank 170 can be replaced by the saddle tank 112 noted above.

When the belt becomes loaded with waste particulates (solids), the filter belt 162 is activated to cause the belt to pass by in close contact with a scraper 172 located at the end of the belt. The scraper 172 extends across below the distal end of the belt so that the particulate on the passing belt is physically scraped off the belt to fall downwardly into a collection trough 174.

The filter belt 162 is also cleaned by spraying clean brine onto the belt. As shown in FIG. 5, jets 176 of clean brine are directed at the lower run 178 of the filter belt 162 to spray the particulate (waste solids) off the belt for collection in the trough 174. As discussed below, the spent brine used to clean the belt 162 is separated from the particulate and then routed back to the primary filter system 110 for processing by the filter system. Thereafter, as with the brine from the injectors that has been filtered by the filter system 110, the spent brine retrieved after being used to clean the belt 162, after being filtered by filter system 110, is routed to the tank 170 and pumped to the saddle tank 112. Or directly to the saddle tank if the tank 170 serves as the saddle tank.

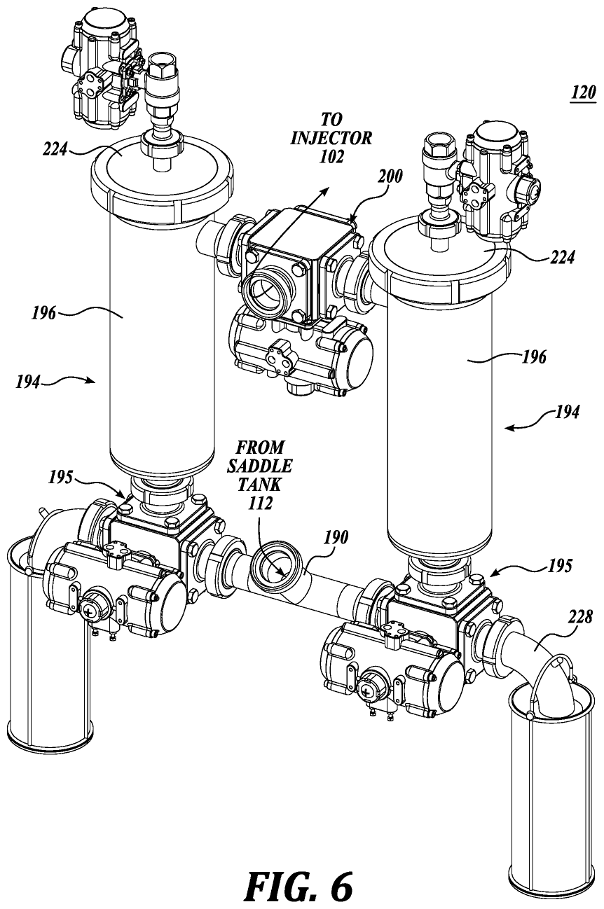

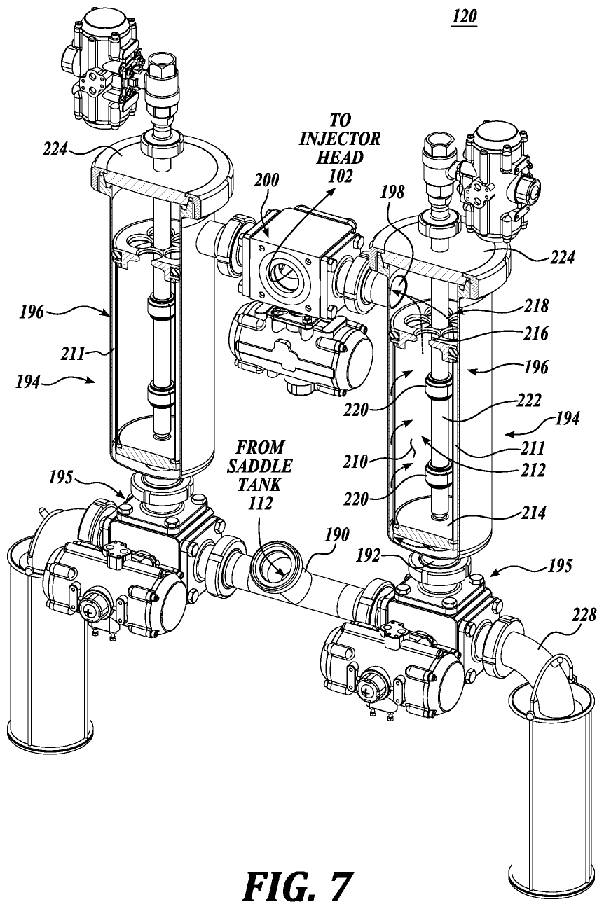

The brine collected in the tank 170 or stored in the saddle tank 112 is further filtered by a secondary filter system 120 so that the brine is in condition to feed the injector head 102 of the injector system 101. See FIGS. 6-8. In this regard, the brine from the tank 170, or the saddle tank 112, is routed to an inlet tee 190 that directs the brine to the lower inlets 192 of a pair of vertical filter units or apparatus 194 via flow control valve 195. The filter units 194 include an outer cylindrical casing 196 that is connected to the inlet 192 and to an upper outlet 198. The outlet 198 is connected to the injector head 102 via flow control valve 200.

A filter element 210 is positioned inside of the casing 196 to filter the brine that enters the casing 196 through the bottom inlet 192. The brine flows upward through an annular space 211 defined by the inside surface of the casing and the exterior of the filter element 210 and then inward though the filter element into the interior chamber 212 formed by the filter element. The particulate in the brine is not able to flow through the filter element 210, but is captured on the exterior of the filter element.

In one exemplary form of the present disclosure, the filter element 210 is in the form of a cylindrical media. In one example, the media can be composed of screen material. In this regard, the mesh size of the screen material is selected to allow the brine to flow from the annular space 211 into the interior chamber 212, but prevents the particulate in the brine from flowing through the screen material. As one example, the screen mesh size can be 1 mm. This mesh size allows the liquid brine to pass through from the annular space 221 into the interior chamber 212.

A bottom cap 214 is affixed to the lower end of the filter element 210 to close off the bottom of the chamber 212. Also, a top cap 216 is affixed to the upper end of the filter element 210 to close off the top of the chamber 212. From the internal chamber 212, the filtered brine flows out through openings 218 formed in the top cap 216, through outlet 198 and then through flow control valve 200 to injector head 102.

A seal 219 extends around the outer circumference of the top cap 216 to close off the annular space 211. The seal also centers the top of the filter element 210 within the casing 196.

Periodically, when sufficient particulate accumulates on the exterior of the filter element 210, the flow of brine to be cleaned (filtered) into the filter unit 194 is terminated by the switching of the inlet valves 195. Also, the flow of the filtered brine out of the filter unit 194 is also terminated by the switching of the outlet valve 200. In this manner, the secondary filter system 120 is isolated from the rest of the system 100 so that the filter element 210 can be cleaned.

With the secondary filter system 120 isolated from the rest of the system 100, clean brine is routed to nozzles 220 mounted on an inlet tube or line 222 extending vertically through the center of the casing 196 and out the top 224 of the casing 196. The upper end of the inlet tube 222 is connected to a source of clean brine.

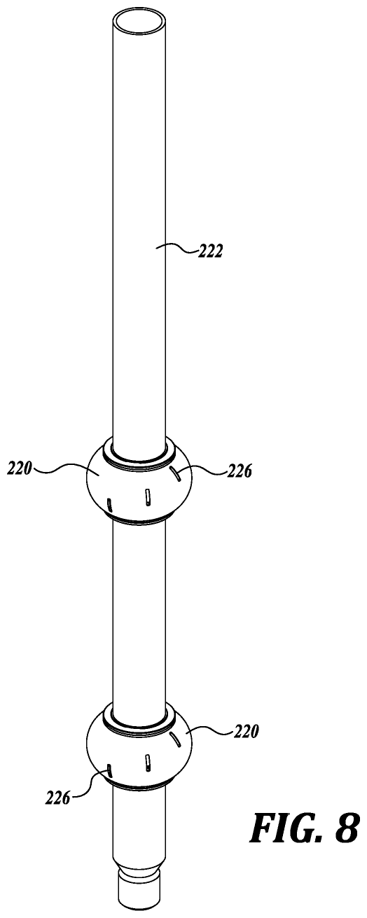

Referring specifically to FIG. 8, the nozzles 220 can be in the form of a torus that encircles the inlet tube 222 to form an interior chamber in brine flow communication with the inlet tube 222. Openings can be provided in the inlet tube 222 for the flow of the clean brine into the interior chamber of the torus shaped nozzle. Openings in the form of vertical slits 226 are formed in the nozzle torus through which the clean brine is directed at the interior side of the filter element 210 to wash the particulate off the exterior of the filter element. The slits are positioned on the torus to direct the clean brine radially horizontally outward from the inlet line 222, as well as radially upwardly and radially downwardly, so as cover the entire surface of the interior of the filter element.

Moreover, although not shown, the inlet tube 222 can be designed to oscillate up and down within the casing 196 and/or designed to rotate about a vertical axis within the casing 196. Either or both of these motions of the inlet tube 222 could help facilitate the removal of the particulate from the exterior surface of the filter element 210.

The particulate washed off of the filter element 210 and the washing fluid that started out in the form of clean brine falls to the bottom of the casing 196 and then flows out through inlet 192, through the flow control valve 195, through a drain line 228 and then into a collector that collects the particulate for further processing and/or disposal. As discussed below, the fluid is separated from the particulate to be routed to the primary filter system 110. This fluid is then filtered in the same manner as the fluid collected from the cleaning of the primary filter system belt and in the same manner as the residual brine from the injection process.

Filter element 210 is held in position and centered within the casing 196 by the inlet tube 222. The closed lower end of the inlet tube 222 engages into a blind hole formed in the center of the bottom cap 214. The inlet tube 22 also engages though a central opening formed in the top cap 216.

In existing filter systems, a scraper is used to scrape the accumulated particulate off the screen of a typical filter element. However, a drawback of this existing cleaning technique is that the scraper forces at least some of the particulate through the filter screen and thus into the flow of the brine that has just been cleaned (filtered). But the use of nozzles in the present disclosure positioned on the “clean side” of the filter screen to wash the particulate off the exterior of the filter screen prevents particulate from entering the flow of filtered brine located within the internal chamber 212.

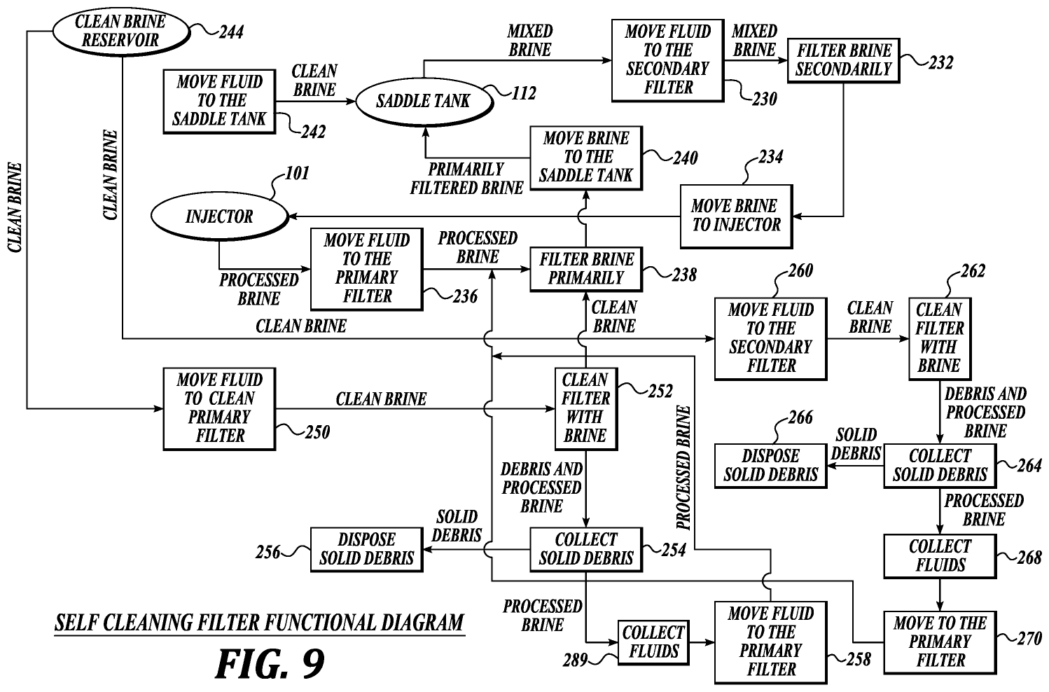

FIG. 9 is a schematic drawing that functionally illustrates the system 100 of the present disclosure. In this regard, saddle tank 112 stores brine for use in supplying the injector system 101. The brine in the saddle tank 112 is moved to the secondary filter system 120 in step 230. Then in step 232, the brine from the saddle tank is filtered by the secondary filter system 120. Thereafter in step 234, the brine filtered by the secondary filter system 120 is move to the injector system 101 for injection into work products.

The residual brine from the injector system is collected and then moved in step 236 to the primary filter, where primary filtering of the collected brine takes place at step 238. The brine thus filtered is returned to the saddle tank at step 240 to be available for reuse.

It will be appreciated that a large proportion of the brine injected into the work product will be retained in the work product, so it will be necessary to replenish the brine in the saddle tank. This can occur in several ways. A first way is for clean brine to be moved in step 242 from a source 244 of the clean brine to the saddle tank in step 242.

As discussed below, another possible source is the brine recovered after being used to clean the primary filter system 110. A further possible source is the brine recovered after being used to clean the secondary filter system 120.

To clean the primary filter system, in step 250, clean brine from source 244 is routed to the primary filet system. Then in step 252, the primary filter system 110 is cleaned as described above using the clean brine.

The particulates or solids removed from the primary filter system via the cleaning thereof are collected at step 254, and disposed of in step 256. Such disposal can include recovering reusable components of the particulates/solids.

In step 258 the fluids collected from the cleaning of the primary filter system are collected and in step 259 moved to the primary filter 110. This fluid is filtered by the primary filter system 110 in the same manner as the brine recovered from the injection system 101. Also, as after filtering the brine recovered from the injection system, the filtered brine recovered from cleaning the primary filter system is moved to the saddle tank as step 240.

To clean the secondary filter system 120, in step 260 clean brine from source 244 is routed to the secondary filter system. Then in step 262 the secondary filter system 120 is cleaned as described above using the clean brine.

The particulates or solids removed from the secondary filter system via the cleaning thereof are collected at step 264 and disposed of in step 266. Such disposal can include recovering reusable components of the particulates/solids.

In step 268, the fluids collected from the cleaning of the secondary filter system is collected and moved to the primary filter 110 in step 270. This fluid is filtered by the primary filter system 110 in the same manner as the brine recovered from the injection system 101 and recovered from cleaning the primary filter system 110. Also, as in after filtering the brine recovered from the injection system and as in after filtering the brine recovered from cleaning the primary filter system 110, the filtered brine recovered from cleaning the secondary filter system 120 is also moved to the saddle tank as step 240.

While illustrative embodiments have been illustrated and described, it will be appreciated that various changes can be made therein without departing from the spirit and scope of the invention.

For example, the primary filter system 110 has been described as being in the form of a belt filter system. However, the primary filter system can be of other forms, for example, a rotary or barrel filter system.

Also, the secondary filter system has been describe as being in the form of a vertical screen filter. However, the secondary filter system can be of other forms, for example, a static filter system that does not require cleaning for long periods, or a filter system with scrapers for removing the particulate that accumulates on the filter screen or other filter element.

In addition, both the primary filter system 110 and the secondary filter system 120 can be used in situations other than with the system 100. Thus, the present disclosure is directed to the primary filter system 110 and/or secondary filter system 120 individually and apart from any filter system, including apart from filter system 110.

Further, both the primary and secondary filters systems are described as being automatically cleaned using clean brine. However, clean water could be used in place of the clean brine. Of course, in this case it will be necessary to process the used water for reuse and/or disposal.

In addition, although two filter units 194 are described and illustrated, it is to be understood that in some situations a single filter unit may be adequate. Or in other situations, more than two filter units 194 may be needed. Thus, the present disclosure is not limited to a specific number of filter units.

Moreover, although nozzles 220 are described as used to remove the particulate from the filter elements 210, other means can be used to perform this function. For example, brushes may be use in place of or in addition to the nozzles to force the particulate off the exterior of the filter elements 210.

Moreover, although nozzles 220 are described as being in configured as slits formed in a chamber mounted on a tube or manifold extending through the cylindrical filter element, the nozzle can be of other configurations, such as a fitting with an outlet opening that is screwed into, or otherwise in fluid flow communication with, the tube or manifold.

The embodiments of the invention in which an exclusive property or privilege is claimed are defined as follows:

1. A filter apparatus comprising:
a cylindrical casing defining an inlet for receiving a liquid to be filtered and an outlet spaced apart from the inlet along the length of the casing for the exiting of the filtered liquid;
a cylindrical filter element disposed within the casing between the inlet and the outlet; the filter element have a diameter sized to define an annular volume between the exterior for the filter element and the interior of the casing, the annular volume in fluid flow communication with the inlet, the filter element having porous end adjacent the outlet for flow of the filtered liquid out the interior of the filter element and through the outlet; and
a plurality of nozzles disposed within the filter element, the nozzles positioned to direct a cleaning fluid at the interior surface of the filter element.

2. The filter apparatus of claim 1, wherein the filter element comprising a closed end cap forming the closed end of the filter element.

3. The filter apparatus of claim 1, wherein the filter element comprising a porous end cap forming the porous end of the filter element.

4. The filter apparatus of claim 1, wherein the filter element comprising a comprising a cylindrical media.

5. The filter apparatus of claim 4, wherein the filter media have a pore size selected to prevent selected particulates from passing through the filter element.

6. The filter apparatus of claim 5, wherein the nozzles are positioned and sized to remove particulates that have accumulated on the exterior of the filter media.

7. The filter apparatus of claim 1, wherein the nozzles are mounted on a tube extending through the cylindrical filter element, the nozzles in fluid flow communication with the tube.

8. The filter apparatus of claim 7, wherein the nozzles are positioned to direct the cleaning fluid radially outwardly from the tube.

9. The filter apparatus of claim 7, wherein the nozzles comprise a torus-shaped chamber extending around the tube.

10. The filter apparatus of claim 9, wherein the nozzles comprise openings in the torus-shaped chamber to direct a cleaning fluid disposed in the torus chamber outward toward the filter element.

11. The filter apparatus of claim 7, wherein the tube is configured to rotate about an axis extending along the length of the tube to in turn rotate the nozzles about the axis.

12. The filter apparatus of claim 7, wherein the tube is configured to translate in a direction along the length of the tube.

13. The filter apparatus of claim 7, wherein the tube engages the filter element to position the filter element concentrically within the casing.

14. The filter apparatus of claim 7, wherein the nozzles comprise a chamber extending around the tube and in fluid flow communication with the tube, the chamber defining openings to direct a cleaning fluid in the chamber outward toward the inner surface of the filter element.

15. The filter apparatus of claim 14, wherein the chamber openings comprise slits in the chamber.

16. The filter apparatus of claim 1, further comprising a valve that is adjustable between a first position to permit a liquid to be filtered to enter the annular volume and a second position to prevent the liquid to be filtered from entering the annular volume while permitting the cleaning fluid emitted by the nozzles to drain from the casing.

17. The filter apparatus of claim 1, further comprising a plurality of casings, each having a filter element disposed therein and each having a plurality of nozzles disposed within the filter element, the nozzles positioned to direct a cleaning fluid at the interior surface of the filter element.

18. The filter apparatus of claim 17, wherein the inlets of the plurality of casings are connected to a common inlet line.

19. The filter apparatus of claim 17, wherein the outlets of the plurality of casings are connected to a common outlet line.
